(19) United States
(12) Patent Application Publication
(10) Pub. No.: US 2024/0053183 A1
(43) Pub. Date: Feb. 15, 2024

(54) MICRO COCKTAIL AND BLENDED BEVERAGE DEVICE AND METHOD OF USE

(71) Applicant: BRAIN BREW VENTURES 3.0, INC., Newtown, OH (US)

(72) Inventor: Douglas B. HALL, Newtown, OH (US)

(21) Appl. No.: 17/766,246

(22) PCT Filed: Oct. 5, 2020
(86) PCT No.: PCT/US2020/054234

§ 371 Date: Apr. 3, 2022

Related U.S. Application Data
(60) Provisional application No. 62/910,641, filed on Oct. 4, 2019.

(51) Int. Cl. G01F 19/00; A47J 43/27

(52) U.S. Cl. CPC G01F 19/002; A47J 43/27; A47J 2203/00

(57) ABSTRACT

The present invention is a measuring device having of a shaft having a first bowl on a first opposing longitudinal end of the shaft and a second bowl on a second opposing longitudinal end of the shaft, such that the first bowl and second bowl are each sized to be between ⅓ to 1/10 of a label on each bowl. The measuring device is used for making micro cocktails that can be easily scaled up.

### CROSS-REFERENCE TO RELATED APPLICATION

The present application claims priority to provisional U.S. Patent Application No. 62/910,641 as filed Oct. 4, 2019.

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND ON THE INVENTION

### 1. Field of the Invention

The present invention relates generally to measuring devices, and more particularly, devices for making cocktails or blends of beverages.

Cocktails and blends of distilled spirits can be expensive to experiment in making. Traditional cocktails can use anywhere between half an ounce to 2 or more ounces of alcoholic spirits. Considering the costs of spirits like bourbon, this can end up costing upwards of $10 per cocktail. And can be even more expensive when blending multiple spirts, such, for example, bourbons, as more spirits are used. As such, many individuals prefer not to experiment in making cocktails or blends of beverages for fear of not liking what they make for themselves and then potentially have wasted the money in the costs of the ingredients.

If people use smaller amounts of ingredients to make a smaller drink, they then need to calculate how to scale up each ingredient while trying to easily remember how much of each was used.

What is needed is a way to easy way to make micro cocktails and blended beverages, that is, very small cocktails or blended beverages, in order to experiment while also providing the actual amount of the same ingredient that would be used in a scaled up, traditional sized cocktail or blended beverage.

### SUMMARY

The various exemplary embodiments of the present invention include a measuring device comprised of a shaft having a first bowl on a first opposing longitudinal end of the shaft and a second bowl on a second opposing longitudinal end of the shaft, such that the first bowl and second bowl are each sized to be between ⅓ to 1/10 of a label on each bowl. The measuring device is used for making micro cocktails that can be easily scaled up.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a perspective view of an exemplary embodiment of the present invention.

### DESCRIPTION OF THE REFERENCED NUMERALS

In reference to the drawings, similar reference characters denote similar elements throughout all the drawings. The following is a list of the reference characters and associated element:
50 Measuring Device
60 Shaft
61 First Opposing Longitudinal End
62 Second Opposing Longitudinal End
70 First Bowl
80 Second Bowl
91 Base
92 Sides
93 Opening

### DETAILED DESCRIPTION

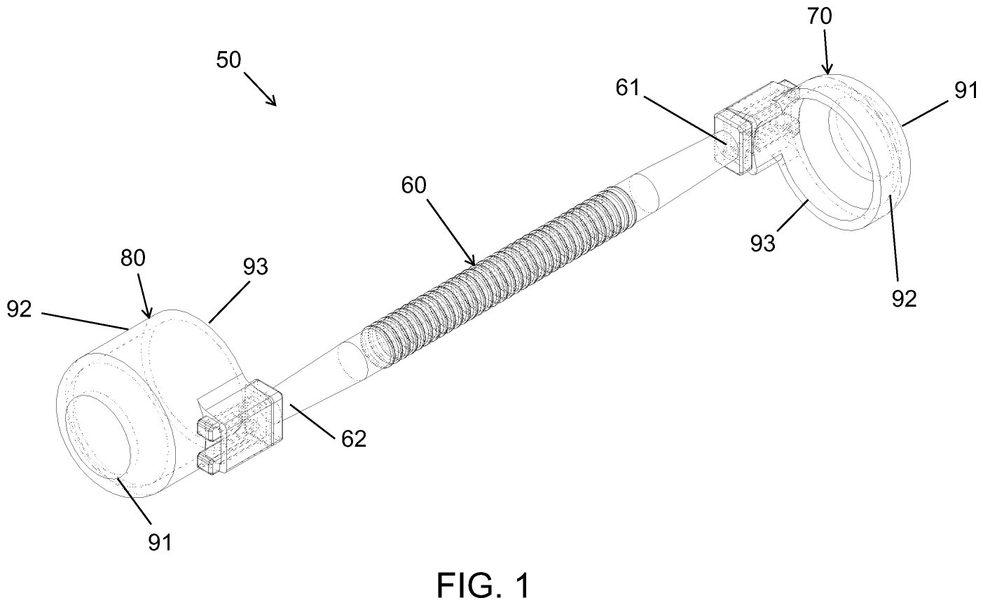

Referring to FIG. 1, the present invention includes a device and method for making micro cocktails.

Throughout this disclosure, the term “cocktail(s)” will be used. The term “cocktail(s)” often is used to reference mixed drinks that include distilled spirits such as whiskey, vodka, rum, gin, etc. mixed with other spirits, non-alcoholic beverages, edibles, or combinations thereof. The term “mocktails” has also grown in popularity to reference non-alcoholic cocktails; which try to mimic the flavors or experience of an actual cocktail without the alcohol. For the sake of brevity and clarity, throughout this disclosure, the term “cocktail” shall include both alcoholic and non-alcoholic type.

The various exemplary embodiments of the present invention include a measuring device 50, an embodiment of which is illustrated in FIG. 1.

The measuring device is comprised of a shaft 60 having a first bowl 70 on a first opposing longitudinal end 61 of the shaft and a second bowl 80 on a second opposing longitudinal end 62 of the shaft.

Each of the first bowl and the second bowl are comprised of a base 91, sides 92, and an opening 93.

The first bowl is connected to the shaft such that the base is the furthest from the first opposing longitudinal end and the opening is closest to the first longitudinal end. The base of the first bowl is preferably substantially perpendicular to the length of the shaft.

The second bowl is connected to the shaft such that the base is the furthest from the second opposing longitudinal end and the opening is closest to the second longitudinal end. The base of the second bowl is preferably substantially perpendicular to the length of the shaft.

Because of the arrangement, the opening of the first bowl and the opening of the second bowl are preferably facing the transverse plane of the shaft.

In an exemplary embodiment, the opening of the first bowl and the opening of the second bowl may be on the same side of the shaft such that the opening of the first bowl is directed to the opening of the second bowl.

In another exemplary embodiment, the opening of the first bowl and the opening of the second bowl face opposing directions but on opposing sides of the shaft. Such exemplary embodiment is illustrated in FIG. 1.

Each of the first bowl and the second bowl are preferably of different measured amounts from one another. In a preferred embodiment, each of the first bowl and the second bowl are labeled with an amount. In exemplary embodiments, the amount/volume labeled on each of the first bowl and the second bowl are a multiple of the actual amount/volume that each bowl holds. In a preferred embodiment, the amount labeled on each of the first bowl and the second bowl is ten times the actual amount that each bowl holds.

Each of the first bowl and second bowl are discretely removably attached to the shaft.

The measuring device is manipulated by a user to portion out ingredients for a cocktail or a blended beverage, wherein the cocktail made is a fraction of the size as the cocktail recipe such that the first and second bowl are labeled as the amount that would be used for making a traditional size cocktail, however, is actually a fraction of the actual label size. For example, the first bowl may be listed as 1 ounce, but will actually be 1/10 of an ounce. This way individuals may better experiment in making cocktails at a lower cost and with less waste, but also not need to later have to scale up measurements of the traditional size cocktail.

The first bowl and second bowl can be sized anywhere from 1/10th to ⅓rd of the respective labeled size.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. A measuring device for making blends of beverages, the measuring device comprising:
a shaft having a first end and a second end opposing the first end, the shaft defining a longitudinal axis, wherein the longitudinal axis extends between the first end and the second end;
a first bowl on the first end; and
a second bowl on the second end,
wherein each of the first bowl and the second bowl are comprised of a base, sides, and an opening, and each of the first bowl and the second bowl define a bowl volume and are labeled with a label volume that is a multiple of the bowl volume, wherein the label volume is larger than the bowl volume.

2. The measuring device according to claim 1, wherein the opening of the first bowl and the opening of the second bowl are facing a transverse plane of the shaft.

3. The measuring device according to claim 2, wherein the first bowl is connected to the shaft such that the base is the furthest from the first end and the opening is closest to the first end and the second bowl is connected to the shaft such that the base is the furthest from the second end and the opening is closest to the second end.

4. The measuring device according to claim 1, wherein the opening of the first bowl and the opening of the second bowl are on a same side of the shaft such that the opening of the first bowl is directed to the opening of the second bowl.

5. The measuring device according to claim 1, wherein the opening of the first bowl and the opening of the second bowl face opposing directions, and the longitudinal axis of the shaft is between a longitudinal axis of the first bowl and a longitudinal axis of the second bowl.

6. The measuring device according to claim 1, wherein each of the first bowl and the second bowl are of different measured amounts from one another.

7. The measuring device according to claim 1, wherein each of the first bowl and second bowl are discretely removably attached to the shaft.

8. The measuring device according to claim 1, wherein the bowl volume is a fraction of the label volume, the fraction being in a range from 1/10 to ⅓.

9. The measuring device according to claim 1, wherein the bowl volume of the first bowl and the bowl volume of the second bowl are different.

10. A method of creating a cocktail or blended beverage with less waste, the method comprising the steps of:
portioning out ingredients using a measuring device, the measuring device comprising:
a shaft having a first end and a second end opposing the first end, the shaft defining a longitudinal axis, wherein the longitudinal axis extends between the first end and the second end;
a first bowl on the first end of the shaft; and
a second bowl on the second end of the shaft,
wherein each of the first bowl and the second bowl are comprised of a base, sides, and an opening, and each of the first bowl and the second bowl define a bowl volume and are labeled with a label volume that is a multiple of the bowl volume, wherein the label volume is larger than the bowl volume; and
placing the portioned out ingredients into a container to make the cocktail or blended beverage.

11. The method according to claim 10, wherein the opening of the first bowl and the opening of the second bowl are facing a transverse plane of the shaft.

12. The method according to claim 11, wherein the first bowl is connected to the shaft such that the base is the furthest from the first end and the opening is closest to the first end and the second bowl is connected to the shaft such that the base is the furthest from the second end and the opening is closest to the second longitudinal end.

13. The method according to claim 10, wherein the opening of the first bowl and the opening of the second bowl are on a same side of the shaft such that the opening of the first bowl is directed to the opening of the second bowl.

14. The method according to claim 10, wherein the opening of the first bowl and the opening of the second bowl face opposing directions, and the longitudinal axis of the shaft is between a longitudinal axis of the first bowl and a longitudinal axis of the second bowl.

15. The method according to claim 10, wherein each of the first bowl and the second bowl are of different measured amounts from one another.

16. The method according to claim 10, wherein each of the first bowl and the second bowl are discretely removably attached to the shaft.

17. The method according to claim 10, wherein the bowl volume is a fraction of the label volume, the fraction being in a range from 1/10 to ⅓.

18. The method according to claim 10, wherein the bowl volume of the first bowl and the bowl volume of the second bowl are different.

19. The measuring device according to claim 1, wherein each of the first bowl and the second bowl define a longitudinal axis, the longitudinal axis of each of the first bowl and the second bowl being spaced apart from and parallel to the longitudinal axis of the shaft.

20. The measuring device according to claim 1, wherein each of the first bowl and the second bowl include an outer wall extending from the sides, the outer wall defining a channel, and wherein the shaft extends through the channel.
